(19) United States
(12) Patent Application Publication
(10) Pub. No.: US 2007/0273159 A1
(43) Pub. Date: Nov. 29, 2007

(54) Thrust Reverser Lock Comprising Locking Device

(75) Inventor: Pascal Gerard Rouyer, Saint Aubin Routot (FR)

Correspondence Address: OLIFF & BERRIDGE, PLC, P.O. BOX 19928, ALEXANDRIA, VA, 22320, US

(73) Assignee: AIRCELLE, GONFREVILLE L'ORCHER (FR)

(21) Appl. No.: 10/571,004

(22) PCT Filed: Sep. 29, 2004
(86) PCT No.: PCT/FR04/02459

§ 371 Date: May 16, 2007

(30) Foreign Application Priority Data
Oct. 6, 2003 (FR) 03.11651

(51) Int. Cl. F02K 1/76

(52) U.S. Cl. 292/201

(57) ABSTRACT

The invention relates to a lock which is intended to be disposed in a thrust reverser and which comprises a bolt and a linking member having a control lever connected thereto. The invention is characterized in that the control lever is equipped with a slot comprising a coupling section, a throttling section and an end section. The invention is further characterized in that a locking pin, which can move against a spring, is equipped with a constriction having a smaller cross-section than that of the throttling section of the slot. In this way, when the constriction is positioned in line with the slot after the locking pin has moved, the control lever can move alternately from a locking position, in which the locking pin is trapped by the end section, to an open position, in which the slot is disengaged from the locking pin.

The present invention relates to a lock intended to be installed in a thrust reverser used in aeronautics, and more particularly to a tertiary lock whose function is to prevent any untimely displacement of the moving parts of a thrust reverser following the putting out of service of the main locks normally disposed on the front frame of said thrust reverser.

A lock of this type is described in the patent application FR 2 830 051 and comprises a bolt intended to be positioned by default in alignment with a slide integral with a fixed longitudinal beam. This slide constitutes a guidance means for a rail attached to the moving parts of the thrust reverser. When the latter has to operate, the control instruction is transmitted from the control cabin and the bolt is then made to move from a locked position, in which it obstructs the displacement of the rail in the direction of opening, to an open position.

It is also known to add a control lever onto a tertiary lock in order to allow the maintenance personnel to test the latter on the ground and to check that the constituent means are integrated and correctly arranged. However, a disadvantage is the fact that the control lever is not locked in rotation and that an untimely opening of the lock in flight is always to be feared. Moreover, this lock does not include any display means, observable from outside, making it possible to indicate if the bolt is in the locked or in the open position.

The purpose of the present invention is to overcome the aforesaid disadvantages and for this purpose consists in a lock comprising, in particular, a bolt and a linking member to which a control lever is connected, said bolt being able, under the action of the control lever on the linking member, to move alternately from a locking position to an open position, characterized in that the control lever comprises a slot substantially perpendicular to the axis of the control lever, this slot successively having an engagement section, a narrow section and an enlarged end section, and in that a locking pin that is mobile in longitudinal translation against an elastic device is disposed parallel with the axis of rotation of the control lever, said locking pin being provided with a recess having a cross section smaller than that of the narrow section of the slot in order that, when this recess is positioned in line with the slot after a displacement in translation of the locking pin, the control lever can move alternately from a locking position, in which the locking pin is trapped by the end section of the slot, to an open position, in which the slot is disengaged from the locking pin.

In this way, any risk of untimely opening is eliminated since the manual unlocking is possible only if several actions are carried out simultaneously. In fact, unlocking can be carried out only if, on the one hand, the recess of the locking pin is maintained in line with the narrow section of the slot and, on the other hand, the control lever is driven in rotation about its axis of rotation. Once the slot of the control lever is disengaged from the locking pin, the latter is then released and moves into a position of rest under the action of the elastic device which tends to return to its original shape. The maintenance personnel can then easily observe from the outside if the lock is open or closed by observing the position of the locking pin. Finally, once the maintenance personnel has checked the integrity of each constituent component of the lock, the lock can be closed in a similar way by simultaneous actions on the locking pin and the control lever.

According to a preferred embodiment of the invention, the end section of the slot is substantially circular, and the recess of the locking pin is situated in the extension of a conical section whose biggest diameter is greater than that of the end section. This then makes it possible to prevent the establishment of a clearance between the end section and the part of locking pin passing through said end section.

Advantageously, the locking pin comprises a groove able to receive the engagement section of the slot when the elastic device is in the rest state. Consequently, in the open position, the engagement section of the control lever can be lowered into the groove of the locking pin and prohibit any displacement in translation of the latter. Preferably, the engagement section of the lever is substantially circular and the diameter of the engagement section is greater than that of the end section. It must be understood that in the absence of such a groove, the engagement section is merged with the narrow section.

Also advantageously, the locking pin comprises a longitudinal window whose length is at least equal to the maximum distance able to be traveled in translation by said locking pin. This longitudinal window can be traversed by a stud integral with a fixed part of said lock in order to prevent the locking pin from being able to pivot about its longitudinal axis.

Preferably, the elastic device bears on a retaining ring positioned around the locking pin.

Furthermore, the locking pin can have, on the one hand, a profiled first end provided to adapt to the aerodynamics of the external lines of the associated thrust reverser and, on the other hand, an enlarged second end able to butt against a fixed part of said lock.

The invention will be better understood with the help of the detailed description which is given below with reference to the appended drawing in which:

FIG. 1 is a perspective view of a lock according to the invention in the locking position.

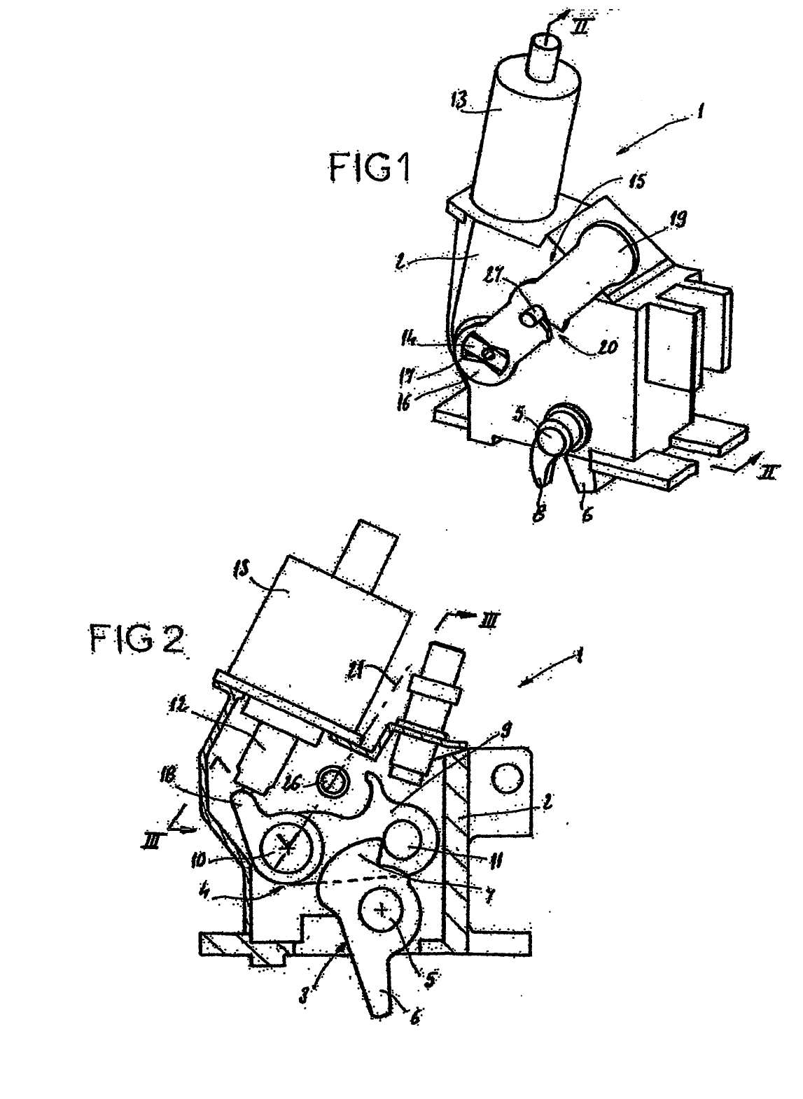

FIG. 2 is a diagrammatic view in cross section along the line II-II of the lock shown in FIG. 1.

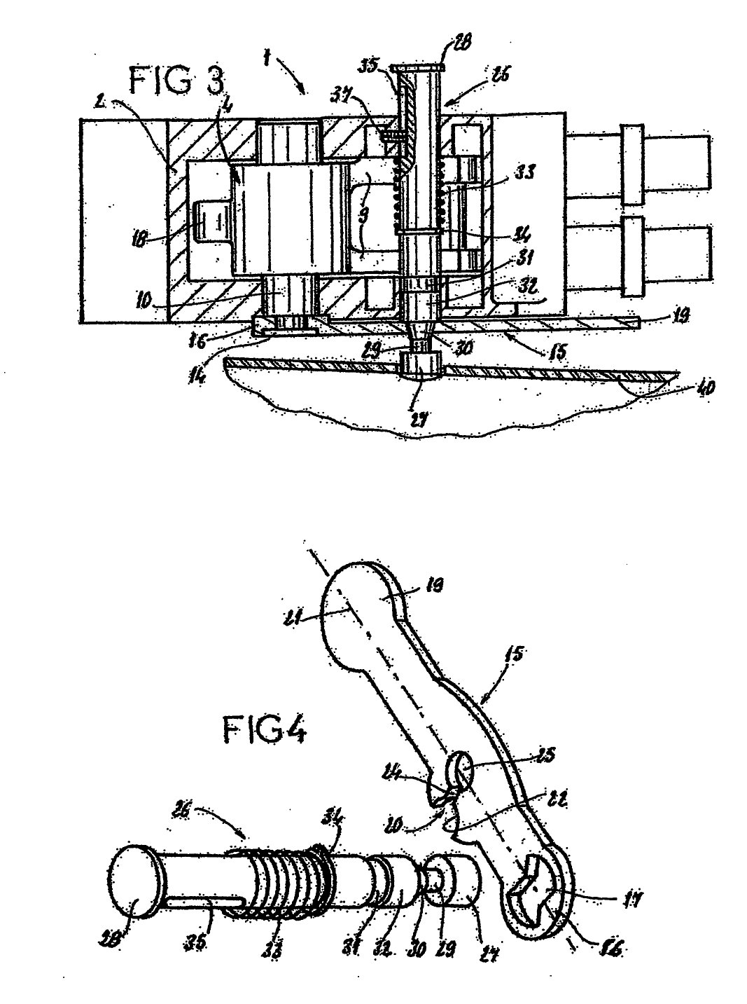

FIG. 3 is a view in cross section along the line III-III of the lock shown in FIG. 2.

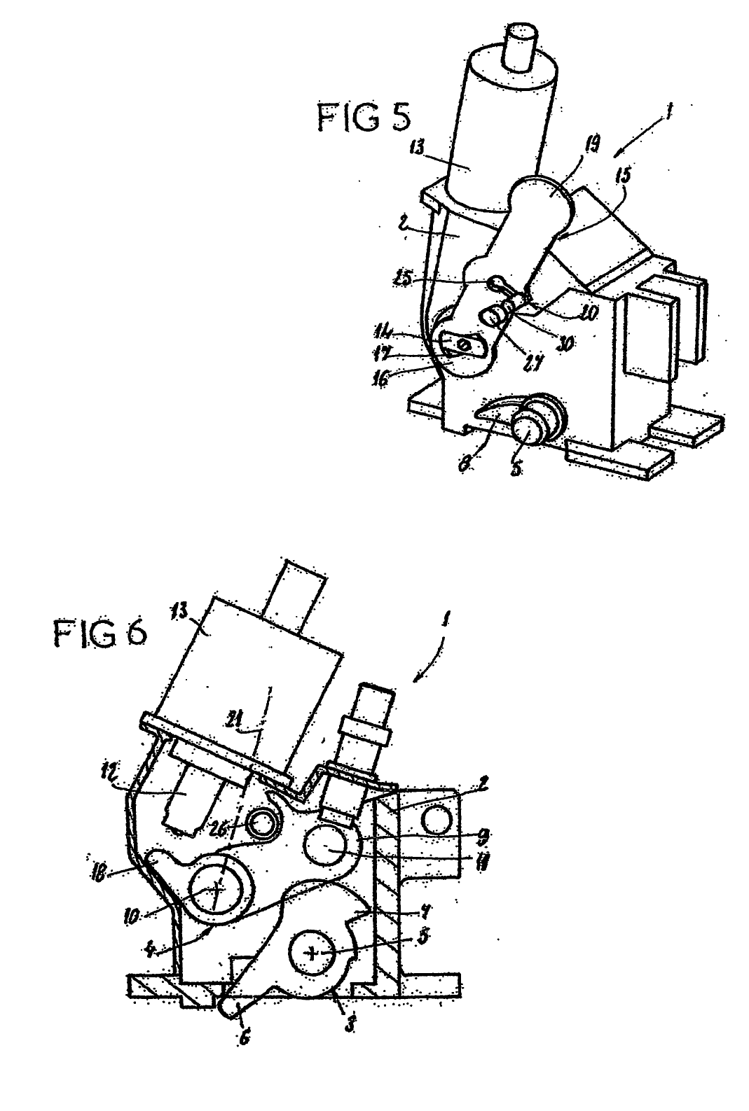

FIG. 4 is an exploded perspective view of the locking pin and of the associated control lever.

FIG. 5 is a view similar to that of FIG. 1 when the lock has been opened manually.

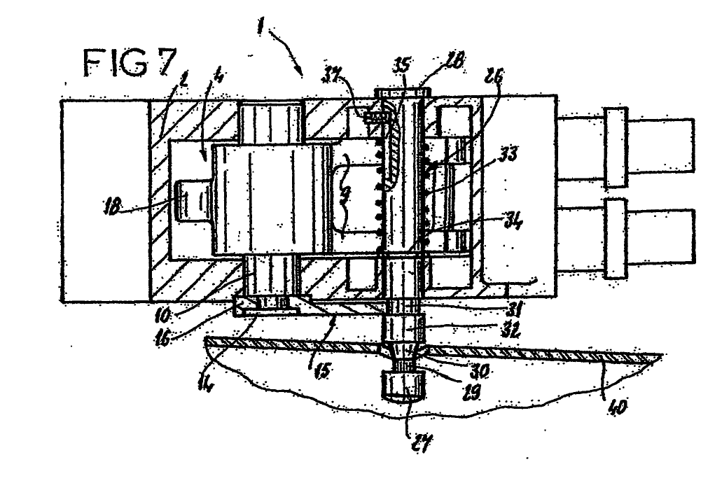

FIG. 6 is a view similar to that of FIG. 2 when the lock has been opened manually.

FIG. 7 is a view similar to that of FIG. 3 when the lock has been opened manually.

A lock 1 according to the present invention, such as shown in FIGS. 1 to 3 and 5 to 7, is a tertiary lock intended to be integrated in a thrust reverser placed around the engine of an airplane, and comprises a body 2 in which are housed, in particular, a bolt 3 and a linking member 4.

More precisely, the bolt 3 consists of a single-piece part able to pivot about a pivot 5 and having, on the one hand, a locking member 6 protruding from the body 2 when the lock 1 is in the closed position and, on the other hand, a protrusion 7 designed to cooperate with the linking member 4. This bolt 3 is integral with a tripping thrust piece 8 disposed outside of the body 2. This tripping thrust piece 8 is mounted around a torsion spring (not shown) which permanently tends to pivot the latter, and therefore the bolt 3, in the clockwise direction.

The linking member 4 is produced from a pair of parallel rods 9 each of which are, at their first end, attached to the same rotational spindle 10 housed in the body 2. This rotational spindle 10 is provided with a thrust piece 18 disposed facing a piston rod 12 controlled by a hydraulic motor 13. These two rods 9 are moreover made integral with each other at their second end by the intermediary of a rod 11 parallel with the rotational spindle 10. The latter comprises an end 14 having a rectangular cross section protruding outside of the body 2.

As shown more precisely in FIGS. 1 and 5, a control lever 15, separate from the body 2, is fitted onto the rotational spindle 10 and is subdivided, on the one hand, into a head 16 provided with an opening 17 shaped like a bow tie and positioned around the end 14 of the rotational spindle 10 and, on the other hand, a lever arm 19 provided with a slot 20 substantially perpendicular to the axis 21 of the control lever 15. More precisely, this slot 20 successively has an enlarged circular engagement section 22, a substantially straight narrow section 24 and an enlarged circular end section 25. The diameter of the engagement section 22 is chosen to be greater than that of the end section 25. A torsion spring (not shown) is positioned around the rotational spindle 10 and permanently tends to pivot the latter, together with the control lever 15, in the clockwise direction.

A locking pin 26 is also incorporated in the body 2 and is disposed parallel with the rotational spindle 10. As shown more precisely in FIGS. 3, 4 and 7, this locking pin 26 in particular comprises a colored and profiled first end 27 which, on the one hand, emerges flush with a bore formed in the external lines 40 of the thrust reverser and, on the other hand, adapts perfectly to the aerodynamics of the latter when the lock 1 is in the locking position. The locking pin 26 also comprises a flat second end 28 having a diameter greater than that of the locking pin 26.

Referring more particularly to FIG. 4, it is observed that this locking pin 26 has a cylindrical recess 29 comprised between the first end 27 and a conical section 30 whose cross section diameter increases towards the second end 28. Furthermore, a groove 31 is formed in the periphery of the locking pin 26 at a distance from the conical section 30, said groove 31 therefore being separated from the latter by a cylindrical section 32. The recess 29, unlike the conical section 30, is designed such that it can pass through the narrow section 24 of the slot 20, and the groove 31 has a diameter substantially equal to that of the engagement section 22.

A spring 33 is positioned around the locking pin 26 and has one end bearing against a retaining ring 34 housed in a circular groove formed halfway along the locking pin 26. The latter furthermore comprises a longitudinal window 35 extending between the second end 28 and the other end of the spring 33. This window 35 is traversed by a stud 37 integral with the body 2 and whose function is to prevent any rotational displacement of the locking pin 26 about its axis, without however preventing the latter from moving in longitudinal translation.

When the lock 1 is in the closed position, as shown in FIGS. 1 to 3, the control lever 15 is folded down onto the locking pin 26 and the end section 25 of the slot 20 is at least partially traversed by the conical section 30 of said locking pin 26. The protrusion 7 of the bolt 3 is butted against the rod 11 of the linking member 4 under the action of its associated torsion spring and this results in the locking member 6 protruding from the body 2.

A person wishing to open the lock 1 manually must press simultaneously on the first end 27 of the locking pin 26 in order to move the latter in longitudinal translation against the spring 33 until the recess 29 is in line with the slot 20, and grasp the lever arm 19 in order to move the control lever 15 in rotation in the anticlockwise direction. It must be noted that, taking account of the particular shape of the opening 17 of the head 16 positioned around the end 14 of the rotational spindle 10, the control lever 15 carries out a null excursion before driving said rotational spindle 10. The locking pin 26 can be released once the slot 20 has been totally disengaged from it. This being done, the spring 33, having been compressed until this time, tends to regain its original shape and consequently forces the locking pin 26 to move in translation in the opposite direction. As shown in FIGS. 5 and 7, the first end 27 of the locking pin 26 then protrudes from the external lines 40 of the thrust reverser and can be noted easily by the maintenance personnel. Finally, the person can release the lever arm 19, the control lever 15 then being obliged to fold down onto the locking pin 26 under the action of the torsion spring (not shown) positioned at the level of the rotational spindle 10. The engagement section 22 of the slot 20 finally comes to lodge in the groove 31 of the locking pin and this results in the latter being henceforth locked in the direction of longitudinal translation.

In order to close the lock 1, it is first necessary to extract the engagement section 22 from the groove 31 and press on the first end 27 of the locking pin 26 in order to place the recess 29 in line with the slot 20. After the tripping thrust piece 8 has been forced to pivot about its pivot 5 in the anticlockwise direction, the control lever 15 can pivot in the clockwise direction until the recess 29 is lodged in the end section 25. The person carrying out the operation can then, on the one hand, release the tripping thrust piece 8 in order that the protrusion 7 of the bolt 3 butts against the rod 11 of the linking member 4 under the action of the torsion spring (not shown) placed around the pivot 5 and, on the other hand, release the locking pin 26, the latter then being rendered mobile in longitudinal translation under the action of the spring 33. The conical section 30 is finally brought to butt against the end section 25 and this results in the control lever 15 being totally locked in rotation.

It must be understood that, during the landing of the airplane, the opening of the lock 1 is carried out conventionally by the intermediary of the piston rod 12 of the hydraulic motor 13 which is able to act on the thrust piece 18 presented by the rotational spindle 10. In this case, the control lever 15 remains permanently in the locking position, as shown in FIGS. 1 to 3. In fact, because of the special shape of the opening 17 of the head 16 of the control lever 15, the end 14 of the rotational spindle 10 can pivot sufficiently, before coming to butt against the edge of said opening 17, for the rod 11 to be able to disengage from the protrusion 7. The bolt 3 can then pivot and the locking member 6 stops obstructing the associated guide in which a rail integral with the moving parts of the thrust reverser can slide. In a conventional manner, in order to close the lock 1, it suffices to command the retraction of the piston rod 12 and to return the tripping thrust piece 8 into position with the help of a hook attached to the moving parts of the thrust reverser.

Even though the invention has been described with reference to particular examples of embodiment, it is of course obvious that it is in no way limited by them and that it comprises all the equivalent techniques of the means described and their combinations if the latter fall within the scope of the invention.

1. A lock intended to be installed in a thrust reverser used in aeronautics, said lock comprising, in particular, a bolt and a linking member to which a control lever is connected, said bolt being able, under the action of the control lever on the linking member, to move alternately from a locking position to an open position, characterized in that the control lever comprises a slot substantially perpendicular to the axis of the control lever, this slot successively having an engagement section, a narrow section and an enlarged end section, and in that a locking pin that is mobile in longitudinal translation against an elastic device is disposed parallel with the axis of rotation of the control lever, said locking pin being provided with a recess having a cross section smaller than that of the narrow section of the slot in order that, when this recess is positioned in line with the slot after a displacement in translation of the locking pin, the control lever can move alternately from a locking position, in which the locking pin is trapped by the end section of the slot, to an open position, in which the slot is disengaged from the locking pin.

2. The lock as claimed in claim 1, characterized in that the end section of the slot is substantially circular, and in that the recess of the locking pin is situated in the extension of a conical section whose biggest diameter is greater than that of the end section.

3. The lock as claimed in claim 1, characterized in that the locking pin comprises a groove able to receive the engagement section of the slot when the elastic device is in the rest state.

4. The lock as claimed in claim 1, characterized in that the engagement section is substantially circular.

5. The lock as claimed in claim 1, characterized in that the diameter of the engagement section is greater than that of the end section.

6. The lock as claimed in claim 1, characterized in that the locking pin comprises a longitudinal window whose length is at least equal to the maximum distance able to be traveled in translation by said locking pin.

7. The lock as claimed in claim 6, characterized in that the longitudinal window is traversed by a stud integral with a fixed part of said lock.

8. The lock as claimed in claim 1, characterized in that the elastic device bears on a retaining ring positioned around the locking pin.

9. The lock as claimed in claim 1, characterized in that the locking pin has a profiled first end provided to adapt to the aerodynamics of the external lines of the associated thrust reverser.

10. The lock as claimed in claim 1, characterized in that the locking pin has an enlarged second end able to butt against a fixed part of said lock.
